(19) United States
(12) Patent Application Publication
(10) Pub. No.: US 2017/0000099 A1
(43) Pub. Date: Jan. 5, 2017

(54) DEVICE AND METHOD OF USE FOR MEASURING FISH

(71) Applicant: Kurt Wanke, San Antonio, TX (US)

(72) Inventor: Kurt Wanke, San Antonio, TX (US)

(21) Appl. No.: 15/200,121

(22) Filed: Jul. 1, 2016

Related U.S. Application Data
(60) Provisional application No. 62/187,779, filed on Jul. 1, 2015.

(51) Int. Cl. A01K 97/00; G01B 3/00; G01B 3/04

(52) U.S. Cl. CPC A01K 97/00; G01B 3/04; G01B 3/004

(57) ABSTRACT

Disclosed herein is a device and method of use for measuring fish. More specifically, the present invention generally relates to a device and method of use for measuring fish individually. Said device allowing for the measurement of the fish with only the device touching the fish during the measurement. That is, the fish does not need to come in direct contact with an individual to perform the length measurement of the fish, which prevents over handling of the fish and possible loss of the fish due to the fish sliding away. In an embodiment, the device is comprised of a cylindrical tube body element having a bottom closed portion with measurement indicia located along the length of the tube. In embodiments, the device is further comprised of openings, which allow fluids to drain from the device. In other embodiments, the openings are positioned on the bottom of the device or the capped end portion. In embodiments, the device is made of a transparent or translucent material.

### CROSS-REFERENCE TO RELATED APPLICATIONS

This application claims the benefit under Title 35 United States Code §119(e) of U.S. Provisional Patent Application Ser. No. 62/187,779; Filed: Jul. 1, 2015, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a device and method of use for measuring fish. More specifically, the present invention generally relates to a device and method of use for measuring fish individually with only the device touching the fish during measurement taking.

### BACKGROUND OF THE INVENTION

Without limiting the scope of the disclosed device, the background is described in connection with a novel device and method of use for measuring the length of fish.

It is often desired or even required to measure the length of a fish. During research for documentation and analysis, a fish length is often desired. Individuals fishing in various jurisdictions are required to determine the length of their caught fish as a minimum length is required, otherwise the fish must be released unharmed.

Check sticks, measuring tape, measuring bars, and variations of these are often used to measure the length of fish.

As a first example, U.S. Pat. No. 5,097,617 issued to Gene C. Craven on Mar. 24, 1992 provides for a v-shaped trough for laying a fish for measurement. While this device provides for the ability to measure a fish, this device has several drawbacks. This device is open allowing the fish to easily remove itself from the trough. This device also requires the user to handle the fish extensively and the device must be on a level surface to operate efficiently. This device also requires multiple hands for the measurement process.

As a second example, U.S. Pat. No. 7,191,536 issued to Ken. D. Bailey on Mar. 20, 1997 provides for a gripping, holding, and measuring fish device. This device also provides for the ability to measure fish, however the measurement taking process is very obtrusive and utilizes a pliable tab that is depressed to restrain the fish. This exposes the fish to possible damage from too much pressure being applied and the excessive handling is detrimental to the fish as well. This device has to be specifically sized for the fish being measured and has an open side portion allowing the fish excessive movement of its tail.

As a third example, U.S. Pat. No. 5,526,575 issued to George R. Hoover et al. on Jun. 18, 1996 provides for a fish measuring device having a wall and a generally v-shaped base. The drawback of this device is v-shaped base having to be tailored to certain sized fish as well as having to orient the fish being measured with the device when the fish is being inserted. In addition, the open wall portion allows the fish to be handled excessively as well as allows the fish excessive movement.

While all of the aforementioned devices may fulfill their unique purposes, none of them fulfill the need for a practical, effective, and efficient means for measuring fish in various environments without the need to handle the fish extensively.

Therefore, the present invention proposes a novel device and method of use for measuring fish.

### BRIEF SUMMARY OF THE INVENTION

The present invention, therefore, provides for a device directed to measuring fish efficiently and in an unobtrusive manner or in a manner that prevents over handling of the fish.

The present invention allows the user to measure the length of fish with only one hand. Other fish measuring devices require a flat surface or the device to be level. In addition, other fish measuring devices require the user to use both hands and require excessive handling and touching of the fish being measured. The present invention is light, flexible, and can easily be transported with the user on their person, boat, raft, canoe, or other transportation.

In one embodiment, the device is comprised of a cylindrical tube body element having a closed bottom portion. The cylindrical tube body element is also comprised of measurement indicia located along the length of the tube from the closed bottom portion to the top open portion. In embodiments, the measurement indicium is located along the interior surface portion of the cylindrical tube body element.

In embodiments, the device is further comprised of opening portions, which allow fluids to drain from the device. In other embodiments, the opening portions are positioned on the closed bottom portion of the cylindrical tube body element. In embodiments, the device is made of a transparent or translucent material.

A user of the device inserts the fish to be measured head first into the top open portion of the cylindrical tube body element. The fish slides down the length of the tube until its head abuts the closed bottom portion of the cylindrical tube body element. The tail or end of the fish provides the measuring point against the measurement indicia to determine the length of the fish. The cylindrical tube body element provides a protective barrier for the fish allowing measurement of the fish without having to excessively handle the fish. By utilizing a cylindrical shape for the cylindrical tube body element, no additional sizing of the device or orientation of the fish while being inserted is needed.

In summary, the present invention discloses a device and method of use for measuring fish. More specifically, the present invention generally relates to a device and method of use for measuring fish individually with only the device touching the fish during measurement taking.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a front side perspective view of the device for measuring fish in accordance with embodiments of the disclosure;

FIG. 2 is a front side view of the device for measuring fish in accordance with embodiments of the disclosure;

FIG. 3 is a back side view of the device for measuring fish in accordance with embodiments of the disclosure;

FIG. 4 is a left side view of the device for measuring fish in accordance with embodiments of the disclosure;

FIG. 5 is a right side view of the device for measuring fish in accordance with embodiments of the disclosure;

FIG. 6 is a top side view of the device for measuring fish in accordance with embodiments of the disclosure;

FIG. 7 is a bottom side view of the device for measuring fish in accordance with embodiments of the disclosure; and

FIG. 8 is an environmental view of the device for measuring fish illustrating how a fish is measured in accordance with embodiments of the disclosure.

### DETAILED DESCRIPTION OF THE INVENTION

Disclosed herein is a device and method of use directed to measuring fish individually with only the device touching the fish during measurement taking. The numerous innovative teachings of the present invention will be described with particular reference to several embodiments (by way of example, and not of limitation).

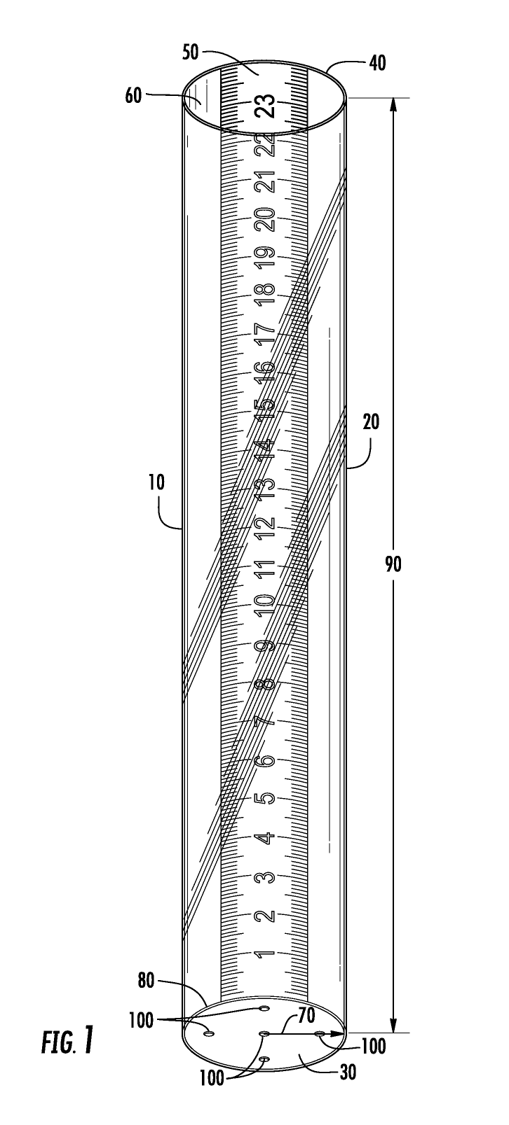

Reference is first made to FIG. 1, a front side perspective view of the device for measuring fish in accordance with embodiments of the disclosure.

In one embodiment, the device is comprised of a cylindrical tube body element having a length 90 running from a bottom closed portion 30 to a top open portion 60. The cylindrical tube body element when viewed from the front has a left side 10, a right side 20, a bottom cylindrical edge 80 and a top cylindrical edge 40. The cylindrical tube body element has a circular cross section with a radius 70.

The cylindrical tube body element is also comprised of measurement indicia 50 located along the length of the tube. In embodiments, the measurement indicia 50 runs along the entire length of the cylindrical tube body element from the closed bottom portion 30 to the top open portion 60. In embodiments, the measurement indicium 50 is located along the interior surface portion of the cylindrical tube body element. In other embodiments, the measurement indicium 50 is located within the cylindrical tube body element walls. The measurement indicia 50 may be of various lengths and units. For example, the measurement indicia may be from zero to eighteen inches and/or from zero to forty-six centimeters. In embodiments, the cylindrical tube body element has multiple measurement indicia 50.

In embodiments, the device is further comprised of opening portions 100, which allow fluids to drain from the device. In other embodiments, the opening portions 100 are positioned on the closed bottom portion 30 of the cylindrical tube body element. These opening portions, in embodiments, are circular openings from the inside of the cylindrical tube body element to the outside of the cylindrical tube body element.

In embodiments, the cylindrical tube body element is at least partially made or has portions that are a transparent or translucent material. In other embodiments, the cylindrical tube body element is completely made of a transparent or translucent material except for the measurement indicia 50.

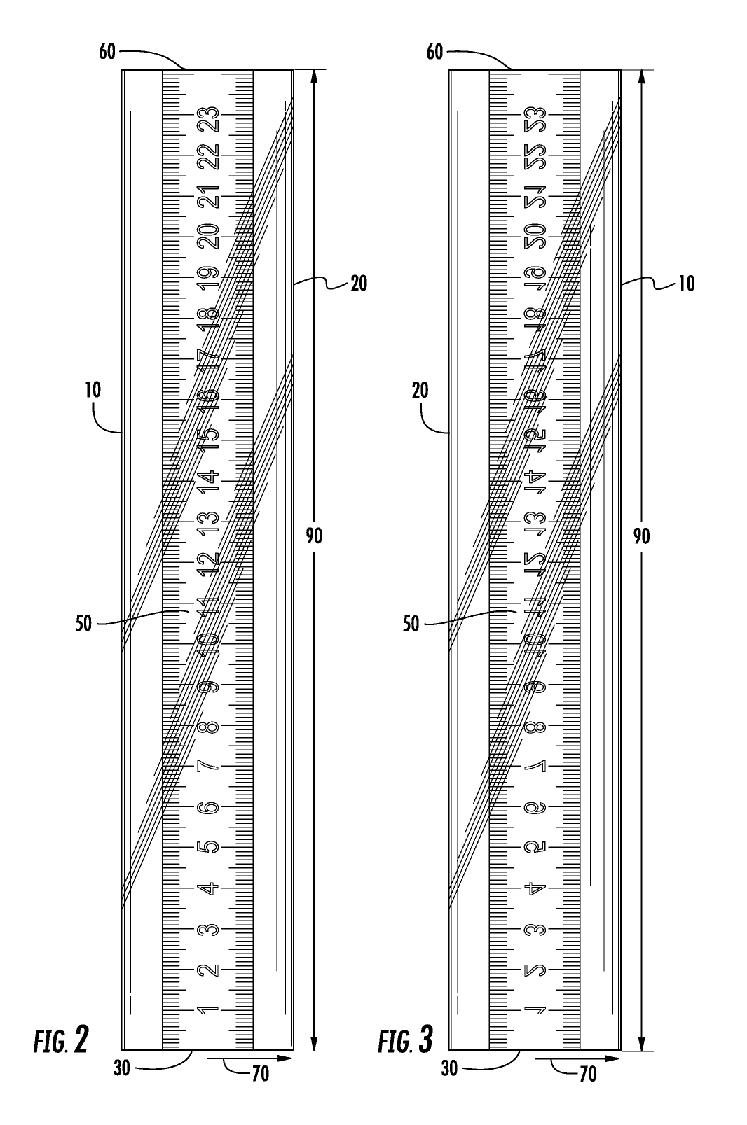

Reference is next made to FIG. 2, a front side view of the device for measuring fish in accordance with embodiments of the disclosure. In this illustration, shown is the measurement indicia 50 running from the bottom closed portion 30 to the top open portion 60 from zero (0) to twenty-four (24) inches along the back interior surface of the cylindrical tube body element. Illustrated in this figure, is are embodiments where the cylindrical tube body element is made of a transparent material, allowing the measurement indicia 50 to be clearly seen through the walls of the cylindrical tube body element. By utilizing a transparent material, the fish can easily be examined and images taken.

Reference is now made to FIG. 3, a back side view of the device for measuring fish in accordance with embodiments of the disclosure. Also shown in this illustration is the measurement indicia 50 running from the bottom closed portion 30 to the top open portion 60 from zero (0) to twenty-four (24) inches along the back interior surface of the cylindrical tube body element.

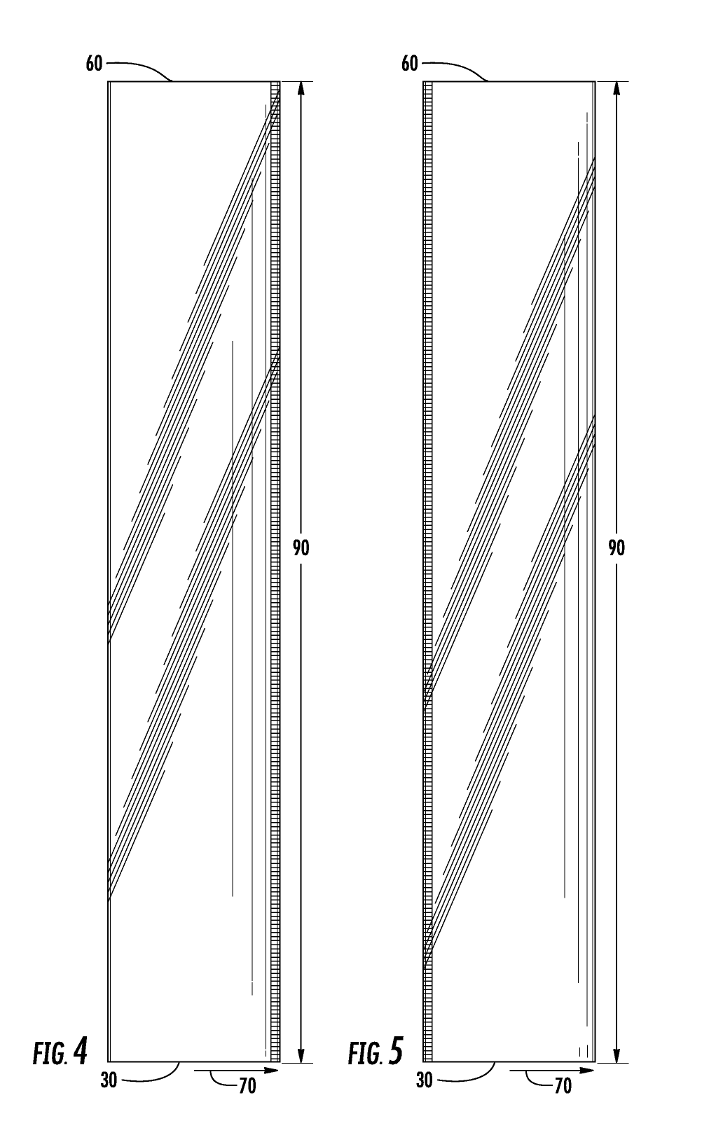

Reference is next made to FIG. 4, a left side view of the device for measuring fish in accordance with embodiments of the disclosure. Illustrated in this view is the circular or tubular shape of the cylindrical tube body element from the left side.

Reference is now made to FIG. 5, a right side view of the device for measuring fish in accordance with embodiments of the disclosure. Illustrated in this view is the circular or tubular shape of the cylindrical tube body element from the right side.

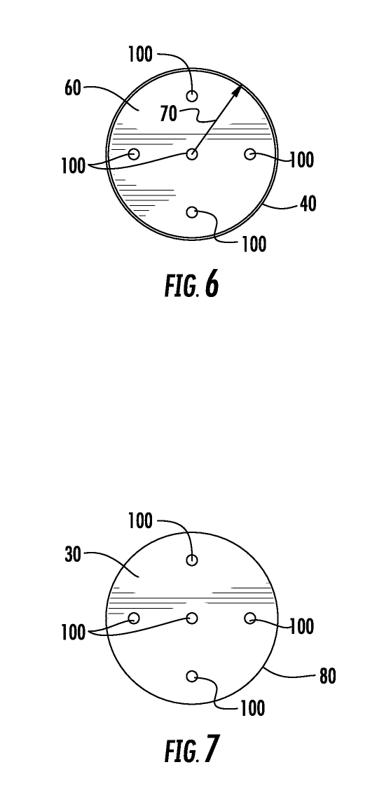

Reference is next made to FIG. 6, a top side view of the device for measuring fish in accordance with embodiments of the disclosure. Illustrated in this view are five opening portions 100 on the bottom closed portion 30 as seen from the top open portion 60. Also more clearly seen is the circular cross sectional radius 70 and the top cylindrical edge 40.

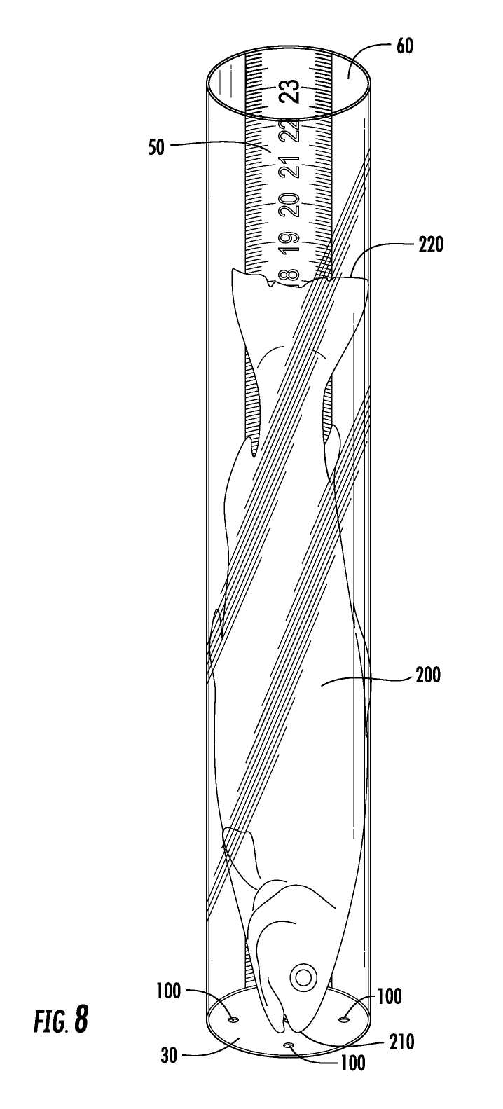

Reference is now made to FIG. 7, a bottom side view of the device for measuring fish in accordance with embodiments of the disclosure. Illustrated in this view also are five opening portions 100 on the bottom closed portion. Also more clearly seen is the circular cross sectional radius 70 from the bottom side and the bottom cylindrical edge 80.

Reference is lastly made to FIG. 8, an environmental view of the device for measuring fish illustrating how a fish is measured in accordance with embodiments of the disclosure.

A user of the device inserts the fish 200 to be measured head 210 first into the top open portion 60 of the cylindrical tube body element. The fish 200 slides down the length 90 of the tube until its head 210 abuts the closed bottom portion 30 of the cylindrical tube body element. The tail 220 or end of the fish 200 provides the measuring point against the measurement indicia 50 to determine the length of the fish 200. The cylindrical tube body element provides a protective barrier for the fish 200 allowing measurement of the fish 200 without having to excessively handle the fish 200. By utilizing a cylindrical shape for the cylindrical tube body element, no additional sizing of the device or orientation of the fish 200 while being inserted or already inserted is needed.

As previously mentioned, by utilizing a transparent material, the fish 200 can easily be examined and images taken. In addition, by having the fish enclosed in the tube, the fish 200 is not able to move excessively and the user is not required to hold the fish 200 with their hands. Both of these benefits provide the user of the device to easily control the fish 200 and not worry about the fish 200 getting away.

The present invention does not require any additional support or other item to be utilized, it does not require a flat surface or to be kept level. The present invention can easily stand on its side, the top open portion, or the bottom closed portion.

In brief, the device is directed to a device and method of use directed to measuring fish individually with only the device touching the fish during measurement taking.

The disclosed device and method is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using this device for game fishing and scientific research use. Consequently, any embodiments comprising a one piece or multi piece device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent applications are herein incorporated by reference to the same extent as if each individual publication, references, patents, or patent application were specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device and/or methods disclosed and claimed herein can be made and executed without undue experimentation in light of the present disclosure. While the device and methods of this invention have been described in terms of preferred embodiments, it will be apparent to those skilled in the art that variations may be applied to the device and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A device for measuring fish comprising:
a cylindrical tube body element having a length running from a bottom closed portion to a top open portion; and
measurement indicia located along the length of said cylindrical tube body element.

2. The device for measuring fish of claim 1, further comprising a bottom cylindrical edge.

3. The device for measuring fish of claim 1, further comprising a top cylindrical edge.

4. The device for measuring fish of claim 1, further comprising a bottom cylindrical edge and a top cylindrical edge.

5. The device for measuring fish of claim 4, wherein said measurement indicia runs the entire length from the bottom closed portion to the top open portion.

6. The device for measuring fish of claim 4, wherein said measurement indicia are positioned on the interior surface portion of said cylindrical tube body element.

7. The device for measuring fish of claim 5, wherein said measurement indicia are positioned on the interior surface portion of said cylindrical tube body element.

8. The device for measuring fish of claim 4, wherein said measurement indicia are positioned within the said cylindrical tube body element walls.

9. The device for measuring fish of claim 5, wherein said measurement indicia are positioned within the said cylindrical tube body element walls.

10. The device for measuring fish of claim 6, wherein said measurement indicia is in inches or centimeters.

11. The device for measuring fish of claim 7, wherein said measurement indicia is in inches or centimeters.

12. The device for measuring fish of claim 8, wherein said measurement indicia is in inches or centimeters.

13. The device for measuring fish of claim 9, wherein said measurement indicia is in inches or centimeters.

14. The device for measuring fish of claim 1, further comprising opening portions.

15. The device for measuring fish of claim 14, wherein said opening portions are positioned on the closed bottom portion.

16. The device for measuring fish of claim 14, wherein said opening portions are circular.

17. The device for measuring fish of claim 1, wherein said cylindrical tube body element is translucent.

18. The device for measuring fish of claim 1, wherein said cylindrical tube body element is transparent.

19. The device for measuring fish of claim 1, wherein said cylindrical tube body element is translucent and transparent.

20. A device for measuring fish comprising:
a cylindrical tube body element having a length running from a bottom closed portion to a top open portion; and
measurement indicia located along the length of said cylindrical tube body element; and
further comprising a bottom cylindrical edge and a top cylindrical edge; and
wherein said measurement indicia runs the entire length from the bottom closed portion to the top open portion; and
wherein said measurement indicia are positioned on the interior surface portion of said cylindrical tube body element; and
wherein said measurement indicia is in inches and centimeters; and
further comprising circular opening portions positioned on the closed bottom portion; and
wherein said cylindrical tube body element is transparent.
